(19) United States
(12) Patent Application Publication
(10) Pub. No.: US 2019/0034937 A1
(43) Pub. Date: Jan. 31, 2019

(54) Problem Prediction Method and System

(71) Applicant: Alibaba Group Holding Limited, Grand Cayman, KY (US)

(72) Inventors: Jiaxing Zhang, Hangzhou (CN); Hengbin Cui, Hangzhou (CN); Shaofei Xue, Hangzhou (CN); Xiaolong Li, Hangzhou (CN)

(21) Appl. No.: 16/146,241

(22) Filed: Sep. 28, 2018

Related U.S. Application Data
(63) Continuation of application No. PCT/CN2017/077728, filed on Mar. 22, 2017.

(30) Foreign Application Priority Data
Mar. 31, 2016 (CN) 201610202932.3

(51) Int. Cl. G06Q 30/00; G06N 5/02

(52) U.S. Cl. CPC G06Q 30/016; G06N 5/022

(57) ABSTRACT

Problem prediction method and system are provided. The prediction method includes receiving a request sent by a client, and obtaining a track of user activities of the client, the track of user activities including at least one of: call information of at least one RPC between the client and a server in a specified time period, or at least one URL of the server accessed by the client; extracting model input data from the track of user activities; and inputting the model input data into a problem classification model to predict a problem. The present disclosure uses a problem classification model to predict a problem, extracts model input data from a track of user activities as features for predicting the problem. In a process of prediction of a problem, manual operations are reduced, and the accuracy of the prediction is improved, while the timeliness is guaranteed at the same time.

### CROSS REFERENCE TO RELATED PATENT APPLICATIONS

This application claims priority to and is a continuation of PCT Patent Application No. PCT/CN2017/077728 filed on 22 Mar. 2017, and is related to and claims priority to Chinese Patent Application No. 201610202932.3, filed on 31 Mar. 2016, entitled “Problem Prediction Method and System,” which are hereby incorporated by reference in their entirety.

### TECHNICAL FIELD

The present disclosure relates to the technical field of the Internet, and particularly to problem prediction methods and systems.

### BACKGROUND

In recent years, with the development of science and technology, various types of activities, such as shopping, appointment/registration, inquiry information, payment, collection etc., have been more and more frequently conducted through networks in the daily lives of people.

However, due to reasons such as network failures, products' defects, and users' unfamiliarity with the products, etc., various problems often occur in actual operations.

For example, today's websites need to set up systems to solve various problems raised by users. Customer service systems of existing websites usually have the following operational process:

1. A user accesses a customer service page through a client or a webpage;

2. A website assigns a customer service staff to the user; and

3. The customer service staff solves a problem for the user.

In the above process, the customer service staff at operation 2 is usually randomly assigned. However, due to the diversity of problems that different users may encounter, a randomly assigned customer service staff may not have enough knowledge reserves to solve the problems of the user and cannot effectively provide solutions, or delay the time of the user when transferring to other customer service staff, resulting in poor user experience when the user accesses the customer service page, and a decrease in a degree of satisfaction of the user.

Accordingly, many websites try to solve problems of users by means of classification. For example, in some websites, when a user visits a customer service page, a dialog box of the customer service page automatically displays content of problem classifications, for example, “Please select a category of a problem you are experiencing: 1. payment problem; 2. password problem; 3. staff service”. After the user selects a corresponding category of a problem, the customer service page is transferred to corresponding customer service staff, and the problem of the user is solved by relatively professional customer service staff under the category of the problem.

For another example, in other scenarios such as a game quiz scenario, a user also needs to enter a problem in a dialog box or select a category of the problem by the user, which is then answered by a system or staff.

However, in the above scenarios, a manner of such classification is essentially performed by a user himself/herself, and the user needs to spend time to understand and select a corresponding category of a problem. After selecting the corresponding category, it is likely that the user also needs to select a second-level problem category under that category of the problem. At the same time, the user may not be able to understand and correctly select a category of a problem, which not only leads to a decrease in the timeliness of solving the problem, but also does not guarantee the accuracy.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

In view of the above problems, embodiments of the present disclosure provide a problem prediction method and a prediction system to overcome the above problems or at least partially solve the above problems.

To solve the above problem, the present disclosure discloses a method for predicting a problem, which includes receiving a request sent by a client, and obtaining a track of user activities of the client, the track of user activities including at least one of: call information of at least one RPC between the client and a server in a specified time period, or at least one URL of the server accessed by the client; extracting model input data from the track of user activities; and inputting the model input data into a problem classification model to predict a problem.

The present disclosure discloses a system for predicting a problem, which includes an acquisition module configured to receive a request sent by a client, and obtain a track of user activities of the client, the track of user activities including at least one of: call information of at least one RPC between the client and a server in a specified time period, or at least one URL of the server accessed by the client; an extraction module configured to extract model input data from the track of user activities; and a problem prediction module configured to input the model input data into a problem classification model to predict a problem.

Compared with existing technologies, the problem prediction method and the prediction system proposed by the embodiments of the present disclosure have at least the following advantages.

In the solutions proposed by the embodiments of the present disclosure, the problem classification model is used to predict a problem that may be raised by a user, which saves time, reduces labor cost, and improves user experience as compared with existing manual or user self-classification methods.

In the solutions proposed by the embodiments of the present disclosure, model input data is extracted from a track of user activities, the track of user activities including call information of at least one RPC between a client and a server in a specified time period, and/or at least one URL of the server accessed by the client. The model input data is inputted into a problem classification model. The problem classification model is used to predict a problem that may be raised by the client, thus saving time and improving the accuracy as compared to the existing manual or user self-service classification methods. At the same time, the model input data which used in prediction of the problem is extracted from the track of user activities. The track of user activities can be extracted from the server in real time, substantially without any delay, thus further saving the time for predicting the problem and improving the accuracy.

### BRIEF DESCRIPTION OF THE DRAWINGS

FIG. 1 is a flowchart of a problem prediction method in accordance with a first embodiment of the present disclosure.

FIG. 2 is a flowchart of a problem prediction method in accordance with a second embodiment of the present disclosure.

FIG. 3 is a block diagram of a problem prediction system in accordance with a third embodiment of the present disclosure.

FIG. 4 is a block diagram of a problem prediction system in accordance with a fourth embodiment of the present disclosure.

### DETAILED DESCRIPTION

The technical solutions in the embodiments of the present disclosure are clearly and completely described herein with reference to the drawings in the embodiments of the present disclosure. Apparently, the described embodiments represent only some and not all of the embodiments of the present disclosure. All other embodiments obtained by one of ordinary skill in the art based on the embodiments of the present disclosure fall within the scope of protection of the present disclosure.

The present disclosure provides a problem prediction method. In the method, firstly, a request sent by a client is received, and a track of user activities of the client is obtained. The track of user activities includes call information of at least one RPC (Remote Procedure Call) between the client and a server in a specified time period, and/or at least one URL of the server accessed by the client. Secondly, model input data is extracted from the track of user activities. Then, the model input data is inputted into a problem classification model to predict a problem. For example, a track of user activities records call information of a RPC or a URL of a page about a transfer failure page that includes transfer failure information when a client encounters a transfer failure. When the client accesses the page, the server receives a request sent by the client, acquires the track of user activities from the server or a specific storage area, and extracts model input data including the transfer failure information from the track of user activities, and inputs the model data input into a problem classification model to predict a problem.

### First Embodiment

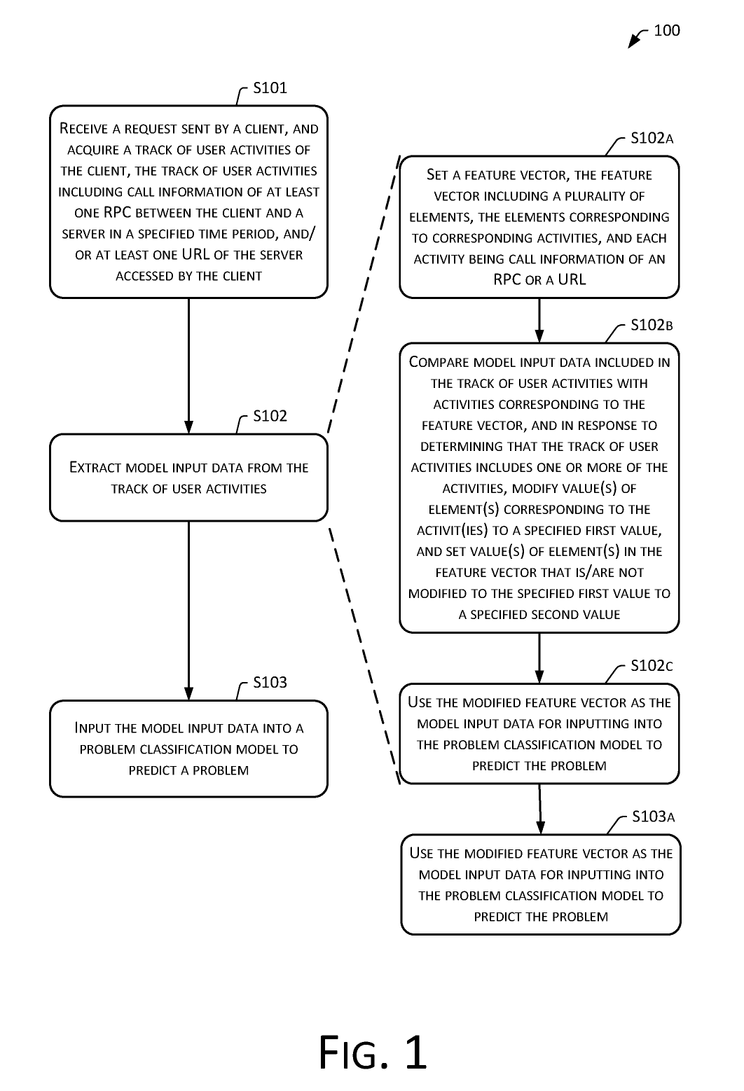

A first embodiment of the present disclosure provides a method 100 for predicting a problem. FIG. 1 is a flowchart of a method for predicting a problem according to the first embodiment of the present disclosure. The method 100 is applied to a server. As shown in FIG. 1, the method 100 includes the following operations.

S101: Receive a request sent by a client, and acquire a track of user activities of the client, the track of user activities including call information of at least one RPC between the client and a server in a specified time period, and/or at least one URL of the server accessed by the client.

In this operation, for example, when a user dials a phone, or when the user opens a mobile app to conduct a self-service query, the user is deemed to have made a request. After receiving the request from a client, a server may obtain a track of user activities corresponding to the client from the server or a specific storage area.

The track of user activities described above may be a time series formed by the user interacting with product(s) during a process of using the product(s). For example, the time series can record that the user opens a transfer page at 12:00, the transfer information and a password at 12:01, and receives a message “Current page does not exist” when accessing the page at 12:02, etc.

In this operation, the server can detect whether the track of user activities is stored in the specified storage area of the server, or can separately set an activity tracking server for recording a track of user activities in the latest time period at any time. When the client makes a request, the latest track of user activities can be retrieved in real time from the activity tracking server as described above.

Specifically, the track of user activities includes call information of at least one RPC between the client and the server within a specified time period, and/or at least one URL of the server accessed by the client.

Examples include interaction information of a RPC between the client and the server, the URL (Uniform Resource Locator) of the server that is accessed by the client, and the like. The above RPC is a remote procedure call protocol, which is a request for a service from a remote computer program over a network. Since interaction information of the RPC is well known to one skilled in the art, further details thereof are provided herein.

When the user uses a mobile terminal, such as a mobile phone, a tablet, or the like, the track of user activities may be call information of a RPC between an application (App) of the client and the server. When the user uses other devices, such as a laptop, a desktop, etc., to access the server through a web page, the track of user activities may be a URL of a web page when the client accesses the server.

For example, when the user accesses the server through a client, or logs into a specific URL through a web page, the client or the web page displays a transfer failure. The above track of user activities may be call information a RPC between the client and the server including transfer failure information, or a URL of a web page including the transfer failure information.

Since the activity tracking server only records original operations of the user with the server (such as RPC and URL as mentioned above), a collection thereof is fast and does not need to be organized, thus ensuring an acquisition of the latest track of user activities. In practical uses, for example, a track of user activities before 30 seconds can be obtained. Correspondingly, a preset time period can be set, for example, as a time period from a specified time point to a receipt of a request from a client, or a time period from a specified time point to 30 seconds before a request sent by a client is received. An example may be a track of user activities generated in a period of time before receiving a request from a client. In this operation, preferably, the specified time period may be, for example, 12 hours to 72 hours, i.e., track of user activities within half a day, or track of user activities within one day, two days, or three days. A track of user activities within 12 hours to a track of user activities within 72 hours are selected, from which at least recent operations of the user are more accurately known. However, the present invention does not particularly limit a range of this specified time period.

In implementations, the user constantly logs into the client using a mobile terminal, such as a mobile phone, and the obtained track of user activities only includes call information of RPC(s) between the client and the server. If the user accesses the server through web page(s), the obtained track of user activities only includes URL(s) of the web page(s). If the user switches between accesses through a mobile terminal and accesses through web page(s), the track of user activities includes both call information of RPC(s) and URL(s) of the web page(s) as described above.

S102: Extract model input data from the track of user activities.

In this operation, model input data may be extracted from the call information of the RPC between the client and the server and/or the URL of web page obtained at operation S101 for subsequent prediction. A number of ways to extract model input data from a track of user activities exist, and are not redundantly described herein.

S103: Input the model input data into a problem classification model to predict a problem.

In this operation, after the model input data is obtained, the model input data can be used as features to input a problem classification model. The problem classification model can be a neural network model generated through training for predicting problems of clients. The problem classification model is, for example, a neural network classification model that is deployed online for predicting user problems. The problem can be, for example, a customer service problem.

For example, when a user accesses a server through a client, or logs into a specific URL through a web page, the client or the webpage displays that the client fails to make a transfer due to the instability of a network system. In such process, call information of a RPC of the client and the server including transfer failure information or an URL of the web page including the transfer failure information is recorded in the server or a specific storage area. After the server receives a request sent by the client, the server obtains a track of user activities corresponding to the user, extracts model input data from the track of user activities, and sends the model input data to the problem classification model. A problem encountered by the client is predicted to be “transfer failure” using the problem classification model. The problem classification model outputs this problem for subsequent operations.

In implementations, operation S102, i.e., extracting the track of user activities of the client with the server from the track of user activities may include the following sub-operations.

S102a: Set a feature vector, the feature vector including a plurality of elements, the elements corresponding to corresponding activities, and each activity being call information of an RPC or a URL.

In this sub-operation, for example, setting a feature vector may be an initialization of the feature vector. For example, a feature vector a (a₁, a₂, a₃, . . . aₙ) may be set to include n elements, and each element corresponds to a corresponding activity. The activity may be an operation of interaction between a client and a server stored in a database, i.e., call information of a RPC or a URL. For example, a₁ corresponds to “server returns a page indicating a transfer failure”, and a₂ corresponds to “server returns a page indicating too many attempts of password inputs”, a₃ corresponds to “server returns a page indicating that an account name does not exist”, and aₙ corresponds to “server cannot receive information sent by user”. In an initialized state, a value of each element can be set to a third value, such as 0, then the feature vector is a (0, 0, 0, . . . 0).

S102b: Compare model input data included in the track of user activities with activities corresponding to the feature vector, and in response to determining that the track of user activities includes one or more of the activities, modify value(s) of element(s) corresponding to the activit(ies) to a specified first value, and set value(s) of element(s) in the feature vector that is/are not modified to the specified first value to a specified second value.

In this sub-operation, for example, the track of user activities includes “server returns a page indicating a transfer failure” and “server returns a page indicating that an account name does not exist”. By comparison, the model input data included in the track of user activities can be determined to be identical to the activities corresponding to the elements a₁ and a₃ in the feature vector. As such, the values of a₁ and a₃ of the feature vector a(0, 0, 0, . . . 0) are modified to a specified first value, for example 1, and the modified feature vector is a(1, 0, 1, . . . 0). The values of the elements in the feature vector that are not modified to the specified first value are set to a specified second value, such as 0. The specified second value herein is the same as the initialized third value when the feature vector is set. In actual operations, these two may be different. For example, the initialized third value may be values other than 1 and 0, etc., and is not extensively described herein.

Preferably, after S102b, the above operation S103a may be performed: using the modified feature vector as the model input data for inputting into the problem classification model to predict the problem.

Operation S103a is the same as or similar to operation S103 described above. For example, for a(1, 0, 1, . . . 0) as described above, such modified feature vector can represent what model input data is included in the track of user activities. For example, in the modified feature vector a as described above, the activities corresponding to the elements a₁ and a₃ whose value is 1 are inputted into the problem classification model to predict the problem.

In short, in the method for predicting a problem provided by the first embodiment of the present disclosure, model input data is extracted from a track of user activities, the track of user activities including call information of at least one RPC between a client and a server in a specified time period, and/or at least one URL of the server accessed by the client. The model input data is inputted into a problem classification model. The problem classification model is used to predict a problem that may be raised by the client, thus saving time and improving the accuracy as compared to the existing manual or user self-service classification methods. At the same time, the model input data which used in prediction of the problem is extracted from the track of user activities. The track of user activities can be extracted from the server in real time, substantially without any delay, thus further saving the time for predicting the problem and improving the accuracy.

### Second Embodiment

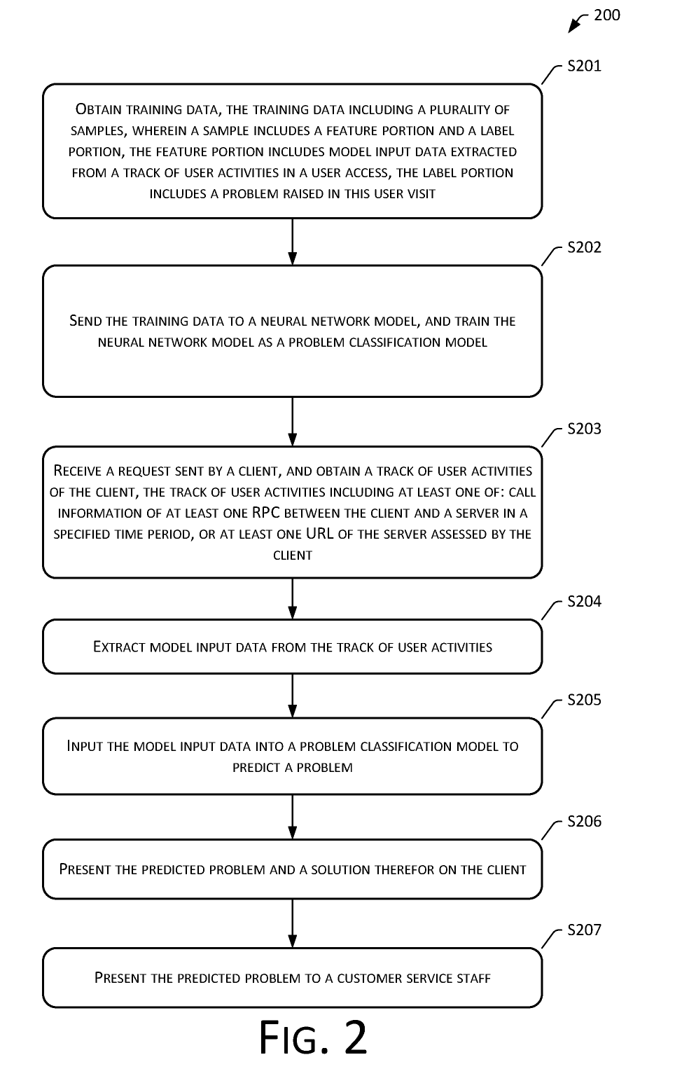

A second embodiment of the present disclosure provides a method for predicting a problem. FIG. 2 is a flowchart of a method for predicting a problem according to the second embodiment of the present disclosure. The method is applied to a server, is used for training a neural network model and predicting a problem. As shown in FIG. 2, the method first trains the neural network model at operations S201 to S202, and then predicts a problem at operations S203 to S205. When training, multiple samples need to be obtained as training data. Each sample includes a label portion and a feature portion. The label portion includes a problem raised in an associated access, the feature portion including model input data extracting from a track of user activities in one visit.

Specifically, the method includes the following operations.

S201: Obtain training data, the training data including a plurality of samples, wherein a sample includes a feature portion and a label portion, the feature portion includes model input data extracted from a track of user activities in a user access, the label portion includes a problem raised in this user visit.

At this operation, the training data may be obtained from a server or a specified storage area, and the training data may be samples associated with accesses of a client in the past month. A sample includes a feature portion and a label portion. The feature portion includes model input data extracted from a track of user activities in a user access. The label portion includes a problem raised in the access, such as a question raised by a user when accessing a web page such as customer service page, a game question-and-answer page, etc., through the client. Therefore, content of each sample includes model input data extracted from a track of user activities during a certain user access, and a question raised by a user in the user access. These two together form a sample.

S202: Send the training data to a neural network model, and train the neural network model as a problem classification model.

A neural network model is a machine learning model that simulates a structure of a brain using neurons and connections therebetween, and is primarily used for classification tasks. For example, neural network model training can receive enough samples of training data and predict problems based on these samples. For example, when a question as “why a transfer fails” corresponding to “server returns transfer failure information” has already existed in a sample of training data received in a neural network model, the neural network model can automatically predict a question of a client to be “why a transfer fails” and perform subsequent operations when a track of user activities sent by the client includes such model input data as “server returns transfer failure information”.

A neural network model training algorithm can adopt a stochastic gradient descent method (SGD). Each sample will make a slight modification to current model parameters along a gradient direction of a current loss function, thereby making the model parameters to be the most optimal at the end. Through the above training data and the training algorithm, a neural network model can be trained as a problem classification model for predicting problems.

S203: Receive a request sent by a client, and obtain a track of user activities of the client, the track of user activities including at least one of: call information of at least one RPC between the client and a server in a specified time period, or at least one URL of the server assessed by the client.

At this operation, for example, when a user dials a phone, or when the user opens a mobile app to conduct a self-service inquiry, the user is deemed to have made a request. After receiving a request from a client, a server may obtain a track of user activities corresponding to the client from the server or a specific storage area.

S204: Extract model input data from the track of user activities.

At this operation, model input data is extracted from the call information of the RPC between the client and the server and/or the URL of a web page obtained at operation S101, to perform a subsequent prediction.

S205: Input the model input data into a problem classification model to predict a problem.

At this operation, after the model input data is obtained, the model input data can be used as features to be inputted into a problem classification model. The problem classification model can be a neural network model generated through training and used for predicting problems of clients. The problem classification model is, for example, a neural network classification model that is deployed online for predicting user problems.

Operations S203 to S205 as described above may be identical or similar to operations S101 to S103, and details thereof are not repeatedly described herein.

In the foregoing two embodiments, after a completion of using the problem classification model to predict the problem, the method may further include:

S206: Present the predicted problem and a solution therefor on the client; and/or

S207: Present the predicted problem to a customer service staff.

For example, when the problem predicted by the problem classification model is “transfer failure”, the server may send a question type of “transfer failure” to a web page opened by the client or the user to present the predicted problem and a solution therefor on the client.

In another situation, after the problem is predicted, the problem can be sent to a customer service staff to solve the problem. For example, the customer service staff can display the predicted problem in an interface used by the customer service staff, so that the staff can quickly and accurately locate the problem.

In summary, in the problem prediction method proposed in the second embodiment of the present disclosure, a problem classification model is used to predict a problem that may be raised by a client, which saves time and improves accuracy as compared to existing methods that rely on labor or user self-classification. At the same time, model input data used to predict the problem is extracted from a track of user activities. The track of user activities can be extracted from a server in real time, substantially without any delay, thus further saving the time for predicting the problem and improving the accuracy. At the same time, a neural network model is also trained by model input data extracted from tracks of user activities. Using the model input data as features can train a more accurate and reliable neural network model, thereby further improving the accuracy of the predicted problem.

### Third Embodiment

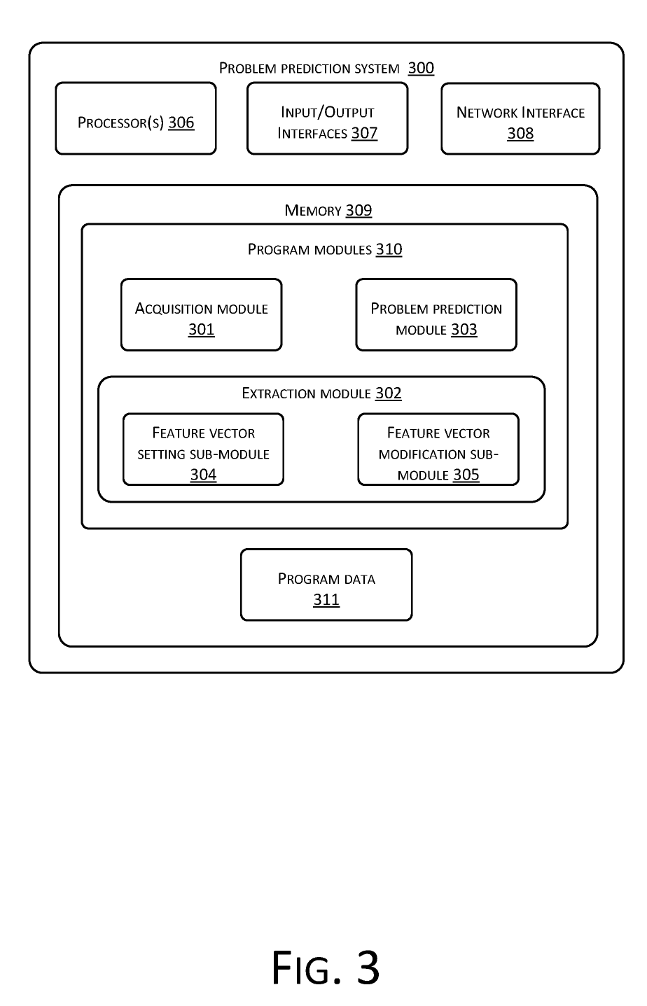

A third embodiment of the present disclosure discloses a problem prediction system. FIG. 3 shows a block diagram of a problem prediction system 300 in accordance with the third embodiment of the present disclosure. In implementations, the system 300 may include one or more computing devices. In implementations, the system 300 may be a part of one or more computing devices, e.g., implemented or run by the one or more computing devices. In implementations, the one or more computing devices may be located in a single place or distributed among a plurality of network devices over a network. In a typical configuration, a computing device includes one or more processors (CPU), an input/output interface, a network interface, and memory.

By way of example and not limitation, as shown in FIG. 3, the system 300 may include an acquisition module 301 configured to receive a request sent by a client, and obtain a track of user activities of the client, the track of user activities including at least one of: call information of at least one RPC between the client and a server in a specified time period, or at least one URL of the server accessed by the client; an extraction module 302 configured to extract model input data from the track of user activities; and a problem prediction module 303 configured to input the model input data into a problem classification model to predict a problem.

In implementations, the extraction module 302 includes a feature vector setting sub-module 304 configured to set a feature vector, the feature vector including a plurality of elements, an element corresponding to a respective activity, and each activity being call information of an RPC or a URL; and a feature vector modification sub-module 305 configured to compare the model input data included in the track of user activities with activities corresponding to the feature vector, and in response to determining that the track of user activities includes one or more of the activities corresponding to the feature vector, modify a value of a corresponding element of the feature vector to a specified first value, and set a value of an element of the feature vector that is not modified to the specified first value to a specified second value.

The problem prediction module 303 is configured to use the modified feature vector as the model input data for inputting into the problem classification model to predict the problem.

In implementations, the system 300 may also include one or more processors 306, an input/output (I/O) interface 307, a network interface 308, and memory 309.

The memory 309 may include a form of computer readable media such as a volatile memory, a random access memory (RAM) and/or a non-volatile memory, for example, a read-only memory (ROM) or a flash RAM. The memory 309 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 309 may include program modules 310 and program data 311. The program modules 310 may include one or more of the foregoing modules and/or sub-modules as described in FIG. 3.

In the problem prediction system disclosed in the third embodiment of the present disclosure, a problem classification model is used to predict a problem that may be raised by a client, which saves time and improves accuracy as compared to existing methods that rely on labor or user self-classification. Furthermore, model input data used for predicting the problem is extracted from a track of user activities. The track of user activities can be extracted from a server substantially in real time without any delay, which further saves the time for predicting the problem and improves the accuracy.

### Fourth Embodiment

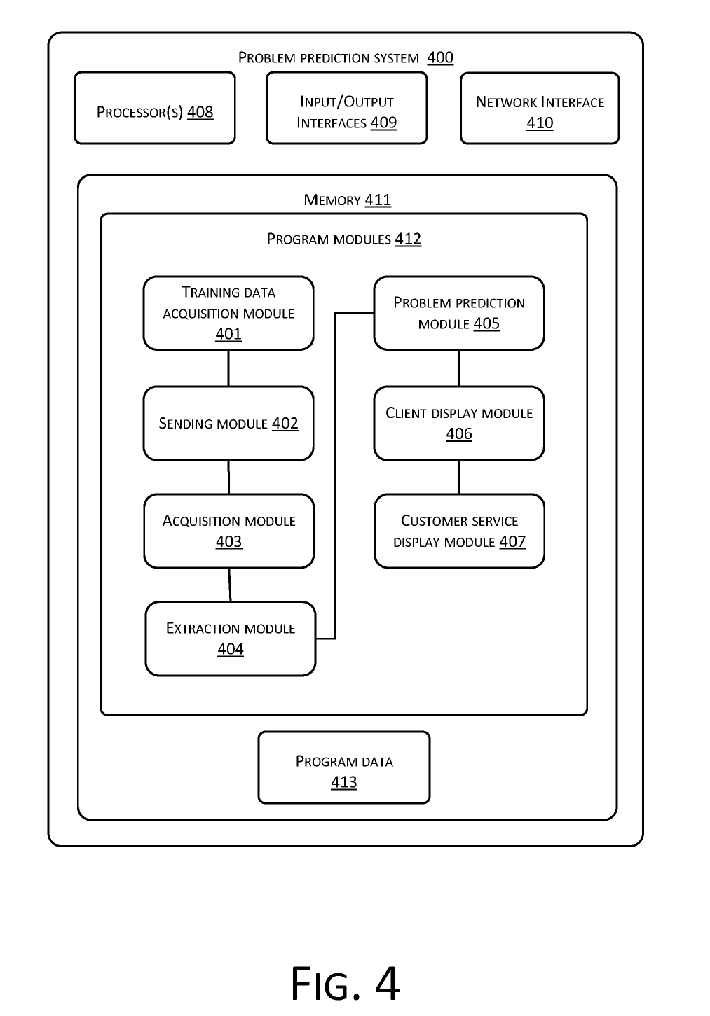

A fourth embodiment of the present disclosure provides a problem prediction system. FIG. 4 shows a block diagram of a problem prediction system 400 according to a fourth embodiment of the present disclosure. In implementations, the system 400 may include one or more computing devices. In implementations, the system 400 may be a part of one or more computing devices, e.g., implemented or run by the one or more computing devices. In implementations, the one or more computing devices may be located in a single place or distributed among a plurality of network devices over a network. In a typical configuration, a computing device includes one or more processors (CPU), an input/output interface, a network interface, and memory. By way of example and not limitation, as shown in FIG. 4, the system 400 may include the following modules.

A training data acquisition module 401 is configured to obtain training data, the training data including a plurality of samples, a sample including a feature portion and a label portion, wherein the feature portion includes model input data extracted from a track of user activities in an access, and the label portion includes a problem raised in the access.

A sending module 402 is configured to send the training data to a neural network model, and train the neural network model as a problem classification model. Specifically, the sending module may be configured to send model input data and a corresponding problem in each sample to the neural network model.

An acquisition module 403 is configured to receive a request sent by a client, and obtain a track of user activities of the client, the track of user activities including at least one of: call information of at least one RPC between the client and a server within a specified time period, or at least one URL of the server accessed by the client.

An extraction module 404 is configured to extract model input data from the track of user activities.

A problem prediction module 405 is configured to input the model input data into a problem classification model to predict a problem.

In implementations, if the problem is a customer service problem, the system 400 further includes at least one of the following modules:

a client display module 406 configured to present the predicted problem and a solution therefor on the client; or

a customer service display module 407 configured to present the predicted problem to a customer service staff.

In implementations, the system 400 may also include one or more processors 408, an input/output (I/O) interface 409, a network interface 410, and memory 411. The memory 411 may include a form of computer readable media as described in the foregoing description.

In implementations, the memory 411 may include program modules 412 and program data 413. The program modules 412 may include one or more of the foregoing modules and/or sub-modules as described in FIG. 4.

In the problem prediction system proposed in the fourth embodiment of the present disclosure, a problem classification model is used to predict a problem that may be raised by a client, which saves time and improves accuracy as compared to existing methods that rely on labor or user self-classification. At the same time, model input data used to predict the problem is extracted from a track of user activities. The track of user activities can be extracted from a server substantially in real time without any delay, thus further saving the time for predicting the problem and improving the accuracy. At the same time, a neural network model is also trained by model input data extracted from tracks of user activities. Using the model input data as features can train a more accurate and reliable neural network model, thereby further improving the accuracy of the predicted problem.

Due to their basically similarities to the method embodiments, the description of the apparatus embodiments is relatively simple, and relevant parts can be referenced to the description of the method embodiments.

Each embodiment in the present specification is described in a progressive manner, and each embodiment has an emphasis that is different from those of other embodiments. Same or similar parts among the embodiments can be referenced with each other.

One skilled in the art should understand that the embodiments of the present disclosure can be provided as a method, an apparatus, or a computer program product. Therefore, the embodiments of the present disclosure may take a form of a complete hardware embodiment, a complete software embodiment, or an embodiment that is a combination of software and hardware. Moreover, the embodiments of the present disclosure may take a form of a computer program product implemented in a form of one or more computer-usable storage media (which include, but are not limited to, a magnetic storage device, CD-ROM, an optical storage device, etc.) having computer-usable program codes embodied therein.

In a typical configuration, a computing device includes one or more processors (CPU), an input/output interface, a network interface, and memory. The memory may include a form of computer readable media such as a volatile memory, a random access memory (RAM) and/or a non-volatile memory, for example, a read-only memory (ROM) or a flash RAM. The memory is an example of a computer readable media. The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

The embodiments of the present disclosure are described with reference to flowcharts and/or block diagrams of methods, terminal devices (systems), and computer program products according to the embodiments of the present disclosure. It should be understood that each flow and/or block in the flowcharts and/or block diagrams, and combinations of the flows and/or blocks in the flowcharts and/or block diagrams may be implemented by computer program instructions. The computer program instructions may be provided to a processor of a general purpose computer, a special purpose computer, an embedded processor, or other programmable data processing terminal device to produce a machine, such that an apparatus is created for implementing functions specified in one or more flows of a flowchart and/or one or more blocks of a block diagram through an execution of the instructions by the processor of the computer or other programmable data processing terminal device.

These computer program instructions may also be stored in a computer readable storage device capable of directing a computer or other programmable data processing terminal device to operate in a specific manner, so that instructions stored in the computer readable storage device generate an article of manufacture including an instruction apparatus. The instruction apparatus implements functions specified in one or more flows of a flowchart and/or one or more blocks of a block diagram.

These computer program instructions may also be loaded onto a computer or other programmable data processing terminal device, such that a series of operating operations are performed on the computer or other programmable terminal device to generate a computer-implemented process. The instructions executed in the computer or other programmable terminal device provide operations for implementing functions specified in one or more flows of a flowchart and/or one or more blocks of a block diagram.

Although the preferred embodiments of the embodiments of the present disclosure have been described, one skilled in the art can make additional changes and modifications to these embodiments once the basic inventive concepts are learned. Therefore, the appended claims are intended to be interpreted as including the preferred embodiments and all changes and modifications that fall within the scope of the embodiments of the present disclosure.

Finally, it should also be noted that relational terms such as first and second, etc., are only used to distinguish one entity or operation from another entity or operation in the present text, and do not necessarily require or imply an existence of any such relationship or order between these operations or entities. Moreover, terms “include”, “contain” or any other variations thereof are intended to cover a non-exclusive inclusion, such that a process, method, article, or terminal device that includes a series of elements includes not only these elements, but also includes other elements that are not explicitly listed, or also includes elements that are inherent in such process, method, article, or terminal device. Without any further limitation, an element defined by a statement “including a . . . ” does not exclude a process, method, article, or terminal device including the element from further including another identical element.

Problem prediction methods and problem prediction systems that are provided in the present disclosure are described in detail above. The present text uses specific examples for illustrating the principles and implementations of the present disclosure. The description of the above embodiments is merely used for facilitating the understanding of the methods and the core ideas of the present disclosure. At the same time, for one of ordinary skill in the art, changes can be made to specific implementations and application scopes based on the ideas of the present disclosure. In summary, the content of the present specification should not be construed as limitations to the present disclosure.

The present disclosure can be further understood using the following clause.

Clause 1: A problem prediction method comprising: receiving a request sent by a client, and obtaining a track of user activities of the client, the track of user activities including at least one of: call information of at least one RPC between the client and a server in a specified time period, or at least one URL of the server accessed by the client; extracting model input data from the track of user activities; and inputting the model input data into a problem classification model to predict a problem.

Clause 2: The problem prediction method of Clause 1, wherein: extracting the model input data from the track of user activities comprises: setting a feature vector, the feature vector including a plurality of elements, an element corresponding to a respective activity, and each activity being call information of an RPC or a URL; comparing the model input data included in the track of user activities with activities corresponding to the feature vector; and in response to determining that the track of user activities includes one or more of the activities corresponding to the feature vector, modifying a value of a corresponding element of the feature vector to a specified first value, and setting a value of an element of the feature vector that is not modified to the specified first value to a specified second value, and inputting the model input data into the problem classification model to predict the problem comprises: using the modified feature vector as the model input data for inputting into the problem classification model to predict the problem.

Clause 3: The problem prediction method of Clause 1, wherein: prior to inputting the model input data into the problem classification model to predict the problem, the method further comprises: obtaining training data, the training data including a plurality of samples, a sample including a feature portion and a label portion, wherein the feature portion includes model input data extracted from a track of user activities in an access, and the label portion includes a problem raised in the access; and sending the training data to a neural network model, and training the neural network model as the problem classification model.

Clause 4: The problem prediction method of Clause 1, wherein the specified time period is 12 hours to 72 hours.

Clause 5: The problem prediction method of Clause 1, wherein: after inputting the model input data into the problem classification model to predict the problem, the method further comprises at least one of the following: presenting the predicted problem and a solution therefor on the client; or presenting the predicted problem to a customer service staff.

Clause 6: A problem prediction system comprising: an acquisition module configured to receive a request sent by a client, and obtain a track of user activities of the client, the track of user activities including at least one of: call information of at least one RPC between the client and a server in a specified time period, or at least one URL of the server accessed by the client; an extraction module configured to extract model input data from the track of user activities; and a problem prediction module configured to input the model input data into a problem classification model to predict a problem.

Clause 7: The problem prediction system of Clause 6, wherein the extraction module comprises: a feature vector setting sub-module configured to set a feature vector, the feature vector including a plurality of elements, an element corresponding to a respective activity, and each activity being call information of an RPC or a URL; and a feature vector modification sub-module configured to compare the model input data included in the track of user activities with activities corresponding to the feature vector, and in response to determining that the track of user activities includes one or more of the activities corresponding to the feature vector, modify a value of a corresponding element of the feature vector to a specified first value, and set a value of an element of the feature vector that is not modified to the specified first value to a specified second value, wherein the problem prediction module is configured to use the modified feature vector as the model input data for inputting into the problem classification model to predict the problem.

Clause 8: The problem prediction system of Clause 7, further comprising: a training data acquisition module configured to obtain training data, the training data including a plurality of samples, a sample including a feature portion and a label portion, wherein the feature portion includes model input data extracted from a track of user activities in an access, and the label portion includes a problem raised in the access; and a sending module configured to send the training data to a neural network model, and train the neural network model as a problem classification model. Specifically, the sending module may be configured to send model input data and a corresponding problem in each sample to the neural network model.

Clause 9: The problem prediction system of Clause 6, wherein the specified time period is 12 hours to 72 hours.

Clause 10: The problem prediction system of Clause 6, further comprising at least one of the following modules: a client display module configured to present the predicted problem and a solution therefor on the client; and/or a customer service display module configured to present the predicted problem to a customer service staff.

What is claimed is:

1. A method implemented by one or more computing devices, the method comprising:
receiving a request sent by a client, and obtaining a track of user activities of the client, the track of user activities including at least one of: call information of at least one RPC between the client and a server in a specified time period, or at least one URL of the server accessed by the client;
extracting model input data from the track of user activities; and
inputting the model input data into a problem classification model to predict a problem.

2. The method of claim 1, wherein extracting the model input data from the track of user activities comprises:
setting a feature vector, the feature vector including a plurality of elements, an element corresponding to a respective activity, and each activity being call information of an RPC or a URL;
comparing the model input data included in the track of user activities with activities corresponding to the feature vector; and
in response to determining that the track of user activities includes one or more of the activities corresponding to the feature vector, modifying a value of a corresponding element of the feature vector to a specified first value, and setting a value of an element of the feature vector that is not modified to the specified first value to a specified second value.

3. The method of claim 2, wherein inputting the model input data into the problem classification model to predict the problem comprises using the modified feature vector as the model input data for inputting into the problem classification model to predict the problem.

4. The method of claim 1, further comprising obtaining training data prior to inputting the model input data into the problem classification model to predict the problem, the training data including a plurality of samples, a sample including a feature portion and a label portion, wherein the feature portion includes model input data extracted from a track of user activities in an access, and the label portion includes a problem raised in the access.

5. The method of claim 4, further comprising sending the training data to a neural network model, and training the neural network model as the problem classification model to inputting the model input data into the problem classification model to predict the problem.

6. The method of claim 1, wherein the specified time period is 12 hours to 72 hours.

7. The method of claim 1, further comprising one or more of:
presenting the predicted problem and a solution therefor on the client; or
presenting the predicted problem to a customer service staff.

8. A system comprising:
one or more processors;
memory;
an acquisition module stored in the memory and executable by the one or more processors to receive a request sent by a client, and obtain a track of user activities of the client, the track of user activities including at least one of: call information of at least one RPC between the client and a server in a specified time period, or at least one URL of the server accessed by the client;
an extraction module in the memory and executable by the one or more processors to extract model input data from the track of user activities; and
a problem prediction module in the memory and executable by the one or more processors to input the model input data into a problem classification model to predict a problem.

9. The system of claim 8, wherein the extraction module comprises:
a feature vector setting sub-module configured to set a feature vector, the feature vector including a plurality of elements, an element corresponding to a respective activity, and each activity being call information of an RPC or a URL; and
a feature vector modification sub-module configured to compare the model input data included in the track of user activities with activities corresponding to the feature vector, and in response to determining that the track of user activities includes one or more of the activities corresponding to the feature vector, modify a value of a corresponding element of the feature vector to a specified first value, and set a value of an element of the feature vector that is not modified to the specified first value to a specified second value.

10. The system of claim 9, wherein the problem prediction module is configured to use the modified feature vector as the model input data for inputting into the problem classification model to predict the problem.

11. The system of claim 8, further comprising a training data acquisition module configured to obtain training data, the training data including a plurality of samples, a sample including a feature portion and a label portion, wherein the feature portion includes model input data extracted from a track of user activities in an access, and the label portion includes a problem raised in the access.

12. The system of claim 11, further comprising a sending module configured to send the training data to a neural network model, and train the neural network model as a problem classification model. Specifically, the sending module may be configured to send model input data and a corresponding problem in each sample to the neural network model.

13. The system of claim 8, further comprising one or more of:
a client display module configured to present the predicted problem and a solution therefor on the client; or
a customer service display module configured to present the predicted problem to a customer service staff.

14. One or more computer readable media storing executable instructions that, when executed by one or more processors, cause the one or more processors to perform acts comprising:
receiving a request sent by a client, and obtaining a track of user activities of the client, the track of user activities including at least one of: call information of at least one RPC between the client and a server in a specified time period, or at least one URL of the server accessed by the client;
extracting model input data from the track of user activities; and
inputting the model input data into a problem classification model to predict a problem.

15. The one or more computer readable media of claim 14, wherein extracting the model input data from the track of user activities comprises:
setting a feature vector, the feature vector including a plurality of elements, an element corresponding to a respective activity, and each activity being call information of an RPC or a URL;
comparing the model input data included in the track of user activities with activities corresponding to the feature vector; and
in response to determining that the track of user activities includes one or more of the activities corresponding to the feature vector, modifying a value of a corresponding element of the feature vector to a specified first value, and setting a value of an element of the feature vector that is not modified to the specified first value to a specified second value.

16. The one or more computer readable media of claim 15, wherein inputting the model input data into the problem classification model to predict the problem comprises using the modified feature vector as the model input data for inputting into the problem classification model to predict the problem.

17. The one or more computer readable media of claim 14, the acts further comprising obtaining training data prior to inputting the model input data into the problem classification model to predict the problem, the training data including a plurality of samples, a sample including a feature portion and a label portion, wherein the feature portion includes model input data extracted from a track of user activities in an access, and the label portion includes a problem raised in the access.

18. The one or more computer readable media of claim 17, the acts further comprising sending the training data to a neural network model, and training the neural network model as the problem classification model to inputting the model input data into the problem classification model to predict the problem.

19. The one or more computer readable media of claim 14, wherein the specified time period is 12 hours to 72 hours.

20. The one or more computer readable media of claim 14, the acts further comprising one or more of:
presenting the predicted problem and a solution therefor on the client; or
presenting the predicted problem to a customer service staff.
